(19) United States
(12) Patent Application Publication
(10) Pub. No.: US 2010/0076836 A1
(43) Pub. Date: Mar. 25, 2010

(54) CONSUMER INFORMATION AND PROMOTION SYSTEM

(75) Inventors: Joseph A. Giordano, Charlotte, NC (US); Christopher Ryan Griggs, Hickory, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: Bank of America Corporation, Charlotte, NC (US)

(21) Appl. No.: 12/234,167

(22) Filed: Sep. 19, 2008

(51) Int. Cl. G06Q 10/00

(52) U.S. Cl. 705/14.38; 705/30; 705/39; 705/16

(57) ABSTRACT

Embodiments of the invention are directed to a system configured to receive and record product-level and consumer-level information about a plurality of consumer transactions across a plurality of merchants in real-time or near real-time. Product marketers can then access this information for marketing purposes. In one embodiment, product marketers store conditional promotional offers on the system and the system determines, for each consumer transaction that it receives information about, whether the consumer or the transaction satisfies the conditions of one or more promotional offers stored on the system. If the conditions of a promotional offer are satisfied, the system sends the offer to the consumer and/or applies the promotion to the current transaction. In one embodiment, the system is maintained by the bank holding the consumer's account and/or issuing the consumer's credit or debit card involved in the transaction.

### FIELD

In general, embodiments of the invention relate to systems, methods, and computer program products for collecting real-time consumer transaction information, providing targeted offers to consumers, and allowing for instant consumer redemption of promotional offers or other rewards.

### BACKGROUND

Consumers are constantly bombarded by a myriad of marketing offers delivered through multiple channels at all times of day. For example, consumers may receive paper coupons and advertisements through the mail, as well as advertisements and offers through email, television, telephone calls, billboards, the Internet, etc.

Many of these marketing offers and advertisements are presented to consumers without regard to the consumer's preferences and without regard to the value of the consumer to the marketer. Depending on how the offer is presented to the consumer, some consumers will find the offers to be too intrusive and not respectful of the consumer's privacy or preferences. Furthermore, many offers are not presented in a timely or convenient manner to be effective. For example, a marketing communication provided by email that advertises a discount on an item purchased in a store may be forgotten and never redeemed if the consumer reads the email at night when the store is closed, or paper-based coupons delivered through the mail may be considered by many consumers to be too cumbersome or inconvenient to carry around.

For the business that is marketing the products, it is often difficult to accurately target the correct consumers at the appropriate times. For example, a company offering a discount to all consumers that purchase a particular product may desire to further offer a greater discount only to repeat customers (i.e., customers that have purchased the product a predefined number of times in a predefined period of time) so as to build long-term customer loyalty. The business may find it difficult to identify only those customers that can be considered repeat customers. Furthermore, it can be difficult and costly, if not impossible, for the company to receive accurate redemption data or other feedback to determine how well a particular offer or marketing campaign is working.

As described in greater detail below, embodiments of the present invention provide systems, methods, and computer program products that solve these problems and/or numerous other problems in the retail environment.

### SUMMARY

Embodiments of the invention are generally directed to a system configured to receive and record product-level and consumer-level information about a plurality of consumer transactions across a plurality of merchants in real-time or near real-time. Product marketers can then access and use this information for marketing purposes. In one embodiment, product marketers store conditional promotional offers on the system and the system determines, for each consumer transaction that it receives information about, whether the consumer or the transaction satisfies the conditions of one or more promotional offers stored on the system. If the conditions of a promotional offer are satisfied, the system sends the offer to the consumer and/or applies the promotion to the current transaction. In one embodiment, the system is maintained by the bank holding the consumer's account and/or issuing the consumer's credit or debit card involved in the transaction.

More particularly, embodiments of the present invention provide a system comprising a memory device, a communication device; and a processing device communicably coupled to the communication device and the memory device. The communication device is configured to receive product-level information and consumer-level information about a plurality of consumer transactions with a plurality of different merchants. The processing device is configured to store the product-level information and consumer-level information in the memory device.

In one embodiment, the product-level information and the consumer-level information are stored in the memory device such that, for each consumer of a plurality of consumers, a record is created of specific products purchased by each consumer over a period of time. In one embodiment, the plurality of consumer transactions comprise consumer transactions involving a credit or debit card.

In one embodiment, the communication device comprises computer-readable instructions embodied in a computer-readable medium and configured to be downloaded onto a processing device held by each of the plurality of different merchants. The computer-readable instructions comprise instructions for routing product-level information from a point-of-sale terminal to the system's processing device via, for example, the Internet. In general, these computer-readable instructions further comprise instructions for communicating with a plurality of point-of-sale terminals.

In one embodiment, the product-level information comprises one or more codes, such as Universal Product Codes (UPCs), that uniquely identify one or more products involved in each consumer transaction.

In one embodiment of the system, the processing device is further configured to access a datastore of promotions offered by a plurality of product marketers. At least some of the promotions generally have one or more conditions, and the processing device is configured to compare the product-level and consumer-level information with the conditions to determine whether any consumers or consumer transactions are eligible for a promotion. If the processor determines that the consumer or the consumer's transaction is eligible for a promotion, the processing device communicates the promotion to a consumer and/or adjusts the amount of the payment transaction based on the promotion. In one embodiment, the datastore of promotions is stored on the system's memory device.

In one embodiment, the system is maintained by a financial institution, such as an issuing bank, involved in electronic payment transactions related to the consumer transactions. In some embodiments, the product-level and consumer-level information are received by the communication device in real-time or near real-time during each consumer transaction.

In some embodiments of the system, the communication device is configured to allow a consumer to access the product-level information stored in the memory device associated with the consumer. The processor may then be configured to print itemized receipts for the consumer for each consumer transaction involving the consumer or the consumer's account. The communication device may also be configured to send the consumer itemized electronic receipts for each consumer transaction involving the consumer or the consumer's account. For example, the communication device may be configured to send the itemized receipts to an electronic device of the consumer's choice.

In still other embodiments of the system, the processing device is further configured to access a datastore of electronic gift cards having one or more conditions for use. The processing device is then configured to compare the product-level information, the consumer-level information, or other transaction information with the conditions to determine if payment for a particular consumer transaction should be deducted from an electronic gift card.

Embodiments of the present invention also provide a method, the method involving: (1) receiving electronic payment transaction information about a first product transaction involving a consumer purchasing one or more products from a first merchant; (2) receiving product identifying information about the identity of each of the one or more products involved in the first product transaction; (3) recording the product identifying information from the first product transaction; (4) receiving electronic payment transaction information about a second product transaction involving the consumer purchasing one or more products from a second merchant different from the first merchant; (5) receiving product identifying information about the identity of each of the one or more products involved in the second product transaction; and (6) recording the product identifying information from the second product transaction. In one embodiment, the method is performed by a financial institution that maintains a consumer account involved in each of the first and second consumer transactions.

In one embodiment of the method, receiving electronic payment transaction information comprises receiving consumer identifying information about the identity of a consumer or a consumer's financial account involved in the product transaction. In such an embodiment, the method may further comprise recording the consumer identifying information and relating it to the recorded product identifying information. The method may also further involve requesting permission from a consumer to allow product marketers to access the product identifying information related to the consumer or the consumer's financial account.

In one embodiment, the method further includes: (1) accessing information about a plurality of promotions, each of said promotions having one or more conditions associated with the promotion; and (2) comparing the product identifying information and the consumer identifying information from the first or second product transactions to determine if the consumer or the first or second transactions qualify for a promotion. In such embodiments, the method may further involve sending the promotion to an electronic device if the consumer or the first or second transactions qualify for the promotion, and/or adjusting the payment transaction information for the first or second product transactions based on the promotion if the consumer or the first or second product transactions qualify for the promotion.

Embodiments of the present invention also provide a method of processing a payment transaction, the method comprising: (1) receiving product identifying information about each of the one or more products that a consumer desires to purchase; (2) receiving information about the consumer's account with a financial institution; and (3) sending the product identifying information to the financial institution. In one embodiment, this method of processing a payment transaction is performed by a product merchant/retailer. As described above, in one embodiment the product identifying information comprises a code that uniquely identifies a product, such as a UPC. In some embodiments of this method, sending the product identifying information to the financial institution comprises sending the product identifying information to the financial institution along with a payment transaction requesting payment from the financial institution for the one or more products.

In one embodiment of the method of processing a payment transaction, the method further involves: (1) sending a payment transaction along a first communication path, the payment transaction requesting payment from the financial institution for the one or more products; and (2) sending the product identifying information to the financial institution along a second communication path different from the first communication path. In such an embodiment, sending the payment transaction along the first communication path may comprise sending the payment transaction to the financial institution indirectly through one or more other institutions. Also, sending the product identifying information to the financial institution along a second communication path different from the first communication path may comprise sending the product identifying information directly to the financial institution via the Internet.

In some embodiments of the method, receiving information about the consumer's account with the financial institution may comprise scanning a consumer's debit or credit card.

In some embodiments, the method further includes receiving promotion information from the financial institution in response to the product identifying information and then presenting the promotion information to the consumer and/or adjusting the payment price based on the promotion information.

Embodiments of the present invention further provide a system comprising a financial institution maintaining a credit or deposit account for a customer, wherein the financial institution is configured to receive product-level information about one or more products being purchased using the customer's credit or deposit account. In such a system, the financial institution may be further configured to record the product-level information and associate it with the customer or the customer's credit or deposit account. The financial institution, in one embodiment, is also configured to provide one or more product marketers access to the product-level information.

In some embodiments of the system, the financial institution is configured to access information about a plurality of promotions, each promotion having one or more conditions, and then compare the product-level information to the plurality of promotions to determine if the customer purchasing the products is eligible for a promotion. In such an embodiment, the financial institution may also be configured to adjust a purchase price for one or more of the products being purchased based on one or more promotions for which the customer is eligible. Alternatively or additionally, the financial institution may be configured to send information to a customer or a merchant about a promotion for which the customer is eligible. In one embodiment, the financial institution is configured to maintain a datastore of the plurality of promotions, and is further configured to receive promotion information from a plurality of product marketers.

In some embodiments, the financial institution is configured to receive product-level information about one or more products being purchased using the customer's credit or deposit account before the purchase is completed. In some embodiments, the financial institution is configured to receive payment transaction information regarding the purchase from a first communication channel and receive the product-level information from a second communication channel and merge the information from the two different communication channels.

Embodiments of the present invention further provide a system comprising: (1) a point-of-sale terminal configured to receive product-level information identifying one or more products being purchased during a consumer transaction, and configured to receive account information identifying a financial account from which to receive payment for the one or more products; and (2) a processing device configured to send the product-level information to the financial institution that maintains the financial account. In such a system, the processing system may be further configured to send the product-level information to the financial institution through a first electronic communication channel, and to send a request for payment for the one or more products to the financial institution through a second electronic communication channel different from the first electronic communication channel. For example, in one embodiment the first electronic communication channel comprises the Internet and the second electronic communication channel comprises a traditional electronic payment channel through, for example, a telecom network.

In one embodiment of the system, the point-of-sale terminal includes a device configured to read a machine-readable code associated with the one or more products in order to receive the product-level information. The point-of-sale terminal may further include a device to read a machine-readable code associated with a consumer in order to receive the account information. In some embodiments, the processing device is configured to receive communication from the financial institution regarding a promotion and send the information about the promotion to the point-of-sale terminal, and the point-of-sale is configured to use a user output device to present information about the promotion to a consumer. In some embodiments, the processing device is configured to receive communication from the financial institution regarding a promotion before the consumer transaction is complete. In some embodiments, the processing device is configured to send the product-level information to the financial institution before the consumer transaction is complete.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating an electronic point-of-sale system in accordance with an embodiment of the present invention;

FIG. 2 is a flow diagram illustrating an electronic payment transaction process in accordance with an embodiment of the present invention;

FIG. 3 is a flow diagram illustrating an electronic payment transaction process in accordance with another embodiment of the present invention;

FIG. 4 is a flow diagram illustrating an advertising procedure in accordance with an embodiment of the present invention;

FIG. 5 is a flow diagram illustrating a procedure for automatic redemption of promotional offers in accordance with an embodiment of the present invention;

FIG. 6 is a flow diagram illustrating a consumer purchase summary process in accordance with an embodiment of the invention; and

FIG. 7 is a flow chart illustrating a process of providing for e-gift cards and the redemption thereof where a consumer uses a bankcard, in accordance with an embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. As used herein and in the claims, the term “product” refers to a tangible item, an intangible item, a service, or a combination of the foregoing. As used herein and in the claims, the term “transaction” can refer to a product purchase, a product return or refund, or other consumer transaction. As used herein and in the claims, the term “promotion” includes advertisements as well as rewards, product discounts, specials, deals, and the like.

To solve the problems described above and/or other problems in the marketing and retail industries, embodiments of the present invention provide a novel electronic payment system and processes that are configured to track and record real-time information regarding consumer transactions at the individual consumer and individual product levels across a plurality of different retailers. In particular, embodiments of the present invention generally involve an issuing bank, or similarly-situated entity in an electronic payment system, receiving and recording product-level data, such as Universal Product Code (UPC) data, for each of its customers' transactions. In one exemplary embodiment, a standardized payment application is downloaded to, for example, a router at each merchant, where the payment application routes product-level data from the merchant to the issuing bank or other entity.

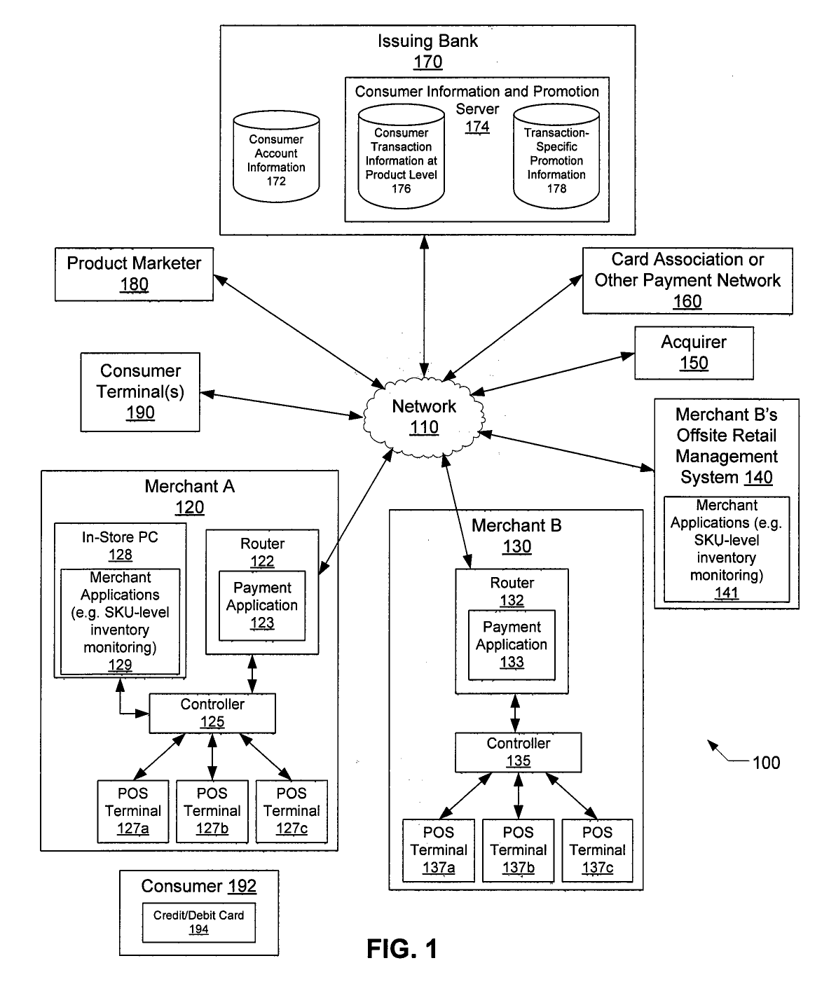

Embodiments of the present invention further provide novel systems and processes for utilizing the recorded consumer transaction information to provide more effective and efficient targeted marketing campaigns, accurate feedback on the effectiveness of such campaigns, instant consumer redemption of promotional offers, consumer purchase receipts, and more detailed account transaction summaries for consumers. For example, in one embodiment the issuing bank maintains a database of its customers' transactions at the individual product level and allows marketers to access the database so that the marketer can offer individualized promotions to the bank's customers based on each specific customer's past product transactions. In one embodiment, the issuing bank also maintains a database of promotions currently available to each individual customer so that the issuing bank can automatically apply a promotion to a customer's purchase at the time when the customer is making a purchase that qualifies for a promotion in the database. These embodiments of the invention and other embodiments of the invention are described below in greater detail with reference to FIGS. 1-7.

As will be appreciated by one of skill in the art, embodiments of the invention may include a method (including a business process), system, computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples of the computer-readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, radio frequency (RF) signals, or other mediums.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

FIG. 1 provides a block diagram illustrating an electronic point-of-sale system 100, in accordance with one embodiment of the present invention. In the illustrated embodiment, several merchants, such as merchant “A” 120 and merchant “B” 130, are communicably coupled via network 110 to various other entities typically involved in processing an electronic payment transaction. In particular, the system 100 includes an acquirer 150, a card association or other payment network 160, and an issuing bank 170, each of which is communicably coupled to at least one of the other entities and/or the merchants via network 110.

Network 110 may be comprised of any type of network and typically includes a combination of several different types of networks. For example, in one embodiment, network 110 includes a global area network (GAN), such as the Internet, a wide area network (WAN), a local area network (LAN), a wireless network, a wireline network, one or more direct connections, a virtual private network (VPN), a telephonic network, a cellular network, and/or an optical network.

In general, a merchant, such as merchant “A” 120 or merchant “B” 130, sells a product to a consumer, such as consumer 192. The consumer 192 may attempt to pay for the product by, for example, scanning a credit or debit card 194 (i.e., a “bankcard”) or other presentment device at one of the merchant's point-of-sale (POS) terminals, such as POS terminal 127a. In this regard, a POS terminal includes user input mechanisms that allow a user to enter information that can be used to identify the consumer and/or the consumer's account at an issuing bank 170 or other financial institution. For example, a POS terminal may contain a device for reading a machine-readable code provided by a user, where the machine-readable code provides information about the consumer and/or the consumer's credit or debit account with an issuing bank or other financial institution. Such a device may include a magnetic strip reader, a barcode scanner, a radio frequency (RF) reader, a character recognition device, a magnetic ink reader, a processor for interpreting codes presented over an electrical or optical medium, a biometric reader such as an a fingerprint reader, and/or the like. In some embodiments, the machine-readable code is carried by the user on a presentment device, such as a credit card, debit card, smart card, rewards card, gift card, mobile phone or other mobile terminal, RFID tag, and/or the like.

In addition to or as an alternative to a machine-readable code reader, the POS terminal may include other devices for capturing and/or relaying information about a consumer or a consumer's account with an issuing bank. For example, in one embodiment, the POS terminal includes a keypad, a touchpad, a voice recognition system, or other user input device.

The POS terminal also includes input mechanisms for receiving information about the one or more products being paid for or returned by the consumer during the transaction. In one embodiment, this mechanism also includes a machine-readable code reader, which may be the same reader as or a different reader from the reader used to receive information about the consumer and/or the consumer's account. In addition to or as an alternative to a machine-readable code reader, the POS terminal may include other devices for capturing and/or relaying information about a product, such as a keypad, a touchpad, a voice recognition system, or other user input device.

In some embodiments, the POS terminal also includes a display device for providing the consumer and/or the merchant with information about the transaction. For example, product information, such as the name, quantity, and/or price of the product may be displayed on the display device for the merchant and/or the consumer. The total price of all products purchased or returned could also be displayed. In some embodiments, the display is also used to prompt the merchant and/or the consumer to approve some aspect of the transaction, such as the total payment amount, or to enter additional information about the transaction, the consumer's account, a product, or the consumer, such as a personal identification number (PIN).

As illustrated in FIG. 1, a merchant, such as merchant “A” 120, may have a plurality of POS terminals, such as POS terminals 127a-127c. In one embodiment, the merchant 120 has a controller 125 that is a central computing device configured to communicate commands to and information from the various POS terminals 127a-127c.

In one embodiment of the invention, the merchant 120 includes a router 122 that provides a gateway between the network 110, such as the Internet, and the controller 125. In one embodiment, the router 122 and 123 of each merchant, such as merchant “A” 120 and merchant “B” 130, includes a payment application 123 and 133, respectively, that controls the flow of information between the POS and the issuing bank 170. The payment application 123 and 133 comprises computer-executable instructions existing on a computer-readable medium, the instructions configured to instruct one or more computing devices to perform certain functions during the processes described in one or more of the figures below. The payment application and the flow of information to and from the POS are described in more detail below.

In one embodiment, the payment application 123 is configured to not only control the information flow between the POS and the issuing bank 170, but is also configured to control the POS terminals 127a-127c, including the prompts, data capture, and data processing functions of the terminals. As such, in one embodiment, the controller 125 and the POS terminals 127a-127c only contain thin software applications since they are primarily controlled by the payment application 123 located on the router 122 or other centralized location. Furthermore, in one embodiment, the payment application is standardized across all or at least a plurality of merchants.

It should be appreciated that this structure described above of the system 100 of embodiments of the present invention is different from conventional electronic point-of-sale payment systems. In a conventional system, the software application for handling the payment transaction resides on each POS terminal and/or the POS terminal's controller. Furthermore, in a conventional system, each merchant may purchase POS terminals and payment software that are different from one another and not standardized. The conventional structure of an electronic point-of-sale payment system makes certain aspects of embodiments of the present invention exceedingly difficult, if not impossible. In contrast, in embodiments of the present invention, the standardization of the payment applications across merchants and the centralized location of the payment application used by each merchant allow one or more issuing banks and/or other institutions to more easily communicate with each merchant in real time and facilitates faster and easier updating of the software when new or improved features are developed for the system.

Although the payment application 123 is illustrated as existing on the router 122, in other embodiments the payment application 123 or portions thereof reside on other devices available to the merchant, such as the controller 125, the POS terminals 127a-127c, or some other computing device connected to the merchant via the network 110, such as the Internet.

In addition to routing the payment transactions to the appropriate financial institution or network, many merchants themselves also desire to track and record information about transactions that take place in their store(s). Merchants typically use such information for tracking inventory. As illustrated in FIG. 1, some merchants, such as merchant “A” 120, have in-store computing devices 128 that run merchant software applications 129 to track information on transactions occurring in the merchant's store, such as stock-keeping unit (SKU) numbers of the products sold and/or returned. As also illustrated in FIG. 1, other merchants, such as merchant “B” 130, have an offsite retail management system 140 that runs merchant software applications 141 to track information on merchant B's transactions occurring in one or more of merchant B's stores. Still other merchants may contract with a third party (not shown) to monitor information about the particular merchant's consumer transactions. As used herein and in the claims, the term “retail host” refers generally to any merchant-controlled consumer transaction tracking system.

Also illustrated in FIG. 1 is an acquirer 150. As known to a person having ordinary skill in the art, an acquirer 150 is often a third party having hardware and software configured to process a merchant's payment transactions by directing the payment transactions to a particular card association or other payment network 160, such as VISA's Visa Access Point (VAP) or MasterCard's MasterCard Interface Processor (MIP). Although only one acquirer 150 is shown in FIG. 1, there may be many acquirers in the electronic payment system 100.

The card association or other payment network 160 is an organization or network of organizations that provides fast and secure communication links between many issuing banks and many acquirers or points-of-sale. For example, in some embodiments of the invention, the card association or other payment network 160 includes VISA, MasterCard, NYCE Payments Network, EPN, ACH, or the like. The card association or other payment network 160 commonly charges a fee per transaction that it processes.

The issuing bank 170 is the bank or other financial institution that maintains a credit or debit account for the consumer 194. The issuing bank 170 or an agent thereof also typically issues the consumer's bankcard or other presentment device. Information about the consumer's account and other consumers' accounts is stored in a consumer account information datastore 172, such as a database, on a memory system. This consumer account information datastore 172 typically includes information about the identity and location of the consumer, the balance of the consumer's account, the limit, if any, on the consumer's account, the bankcard numbers, PINs, or other code information or presentment device information, etc.

As also illustrated in FIG. 1, the issuing bank 170 maintains a consumer information and promotion server 174 which comprises a consumer transaction information datastore 176 and a transaction-specific promotion information datastore 178. As described in greater detail below, the consumer transaction datastore 176 contains such information as the consumer involved in the transaction, the merchant involved in the transaction, UPC data or other indicators of the specific products involved in the transaction, the total price of the transaction, the price of each product involved in the transaction, the time and date of the transaction, the location of the transaction, and/or the like.

As also described in greater detail below, the transaction-specific promotion information datastore 178 contains information from product marketers 180 and/or merchants regarding specific promotions that are available to one or more consumers. For example, the promotion information may include information about specific advertisements, discounts, offers, and rewards, as well as specific information about which transactions are eligible to receive the advertisement, discount, offer, or reward. For example, in one embodiment an advertisement, discount, offer, or reward is eligible only for a transaction involving a specific consumer, group of consumers, merchant, group of merchants, product, group of products, time of day or date, geographic location, or some combination of the foregoing.

As described in more detail below, in some embodiments the server 174 allows other parties, such as product marketers 180, to access the information contained in the datastores 176 and 178. Furthermore, although FIG. 1 illustrates that the issuing bank 170 maintains the consumer information and promotion server 174, in other embodiments of the invention, the server is maintained by an agent of the issuing bank or by some other entity similarly situated in the payment system to be able to receive consumer and product-level retail transaction information across a plurality of retailers. Furthermore, although only one issuing bank 170 and one consumer 192 are illustrated in FIG. 1, the system 100 may comprise many issuing banks and many consumers. In one embodiment, several issuing banks contract with each other to combine consumer information and promotion databases and/or contract with a third party to maintain the consumer information and promotions server 174.

Although FIG. 1 illustrates the acquirer 150, the payment network 160, and the issuing bank 170 as separate entities, in other embodiments of the invention two or more of these entities are combined into a single entity. For example, American Express is basically a combination of the acquirer 150, the payment network 160, and the issuing bank 170. Furthermore, other entities not shown in FIG. 1 could, in some embodiments, be involved in the payment transaction to perform other functions.

FIG. 1 also illustrates a product marketer 180. The product marketer 180 is a business or other entity concerned with marketing one or more products. In this regard, the product marketer 180 may be, for example, a product manufacturer or provider, distributor, retailer, merchant, advertising firm, or the like. In one embodiment, the product marketer 180 can communicably couple itself with the consumer information and promotion server 174 via network 110 in order to access information stored in the consumer transaction information datastore 176 and/or to provide information for the transaction-specific promotion information datastore 178. Although only a single product marketer 180 is depicted in FIG. 1, the system 100 may contain numerous product marketers.

FIG. 1 also illustrates a consumer terminal 190. The consumer terminal 190 is a computing device that allows a user to access, via network 110, information maintained by the issuing bank 170, such as consumer account information 172, consumer transaction information 176, and perhaps some of the transaction-specific promotion information 178. In this way, a consumer 192 may be able to view his or her account information, generate product-specific expenditure summaries, and print detailed retail transaction receipts, as described in greater detail below. The consumer terminal 190 may be, for example, a desktop personal computer, an automated teller machine (ATM), or mobile terminal, such as a cellular phone, personal data assistant (PDA), laptop, or the like. Although only a single consumer terminal 190 is depicted in FIG. 1, the system 100 may contain numerous consumer terminals.

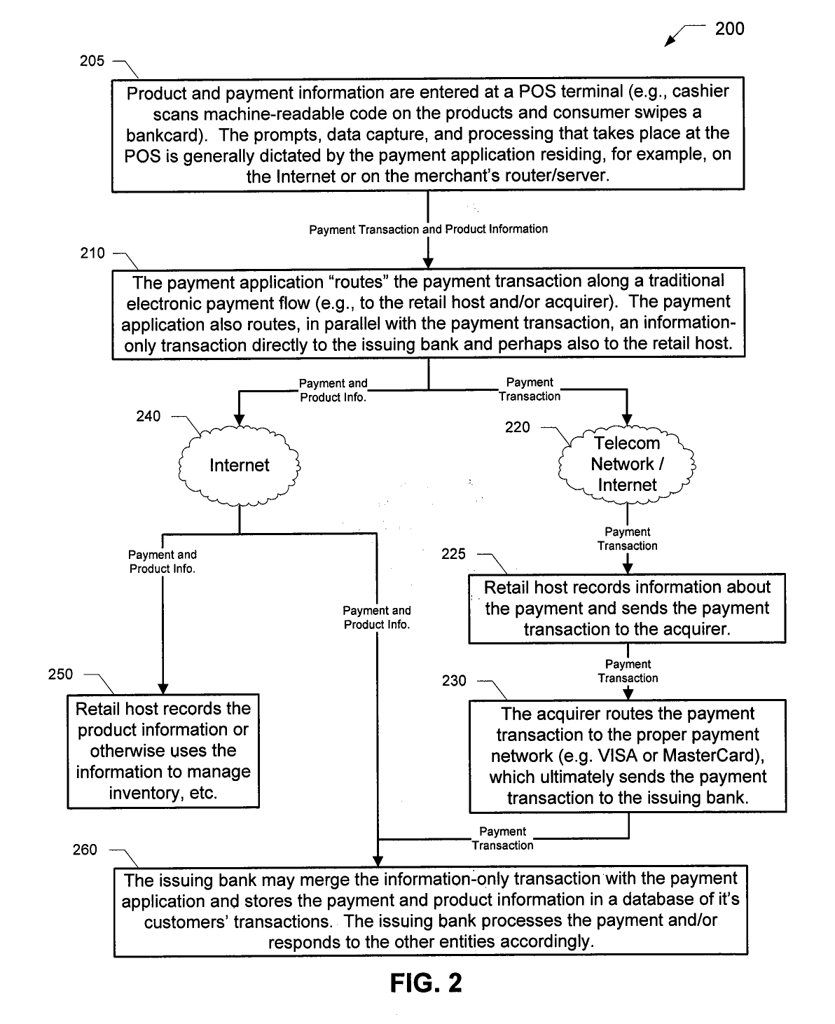

FIG. 2 is a flow diagram illustrating an electronic payment transaction process 200 in accordance with an embodiment of the present invention. As represented by block 205, during a transaction between a consumer 102 and a merchant 120, product and payment information are entered at a POS terminal 127. For example, in one embodiment product information, such as UPC data, SKU numbers, and/or other product identifiers, is entered by a cashier scanning a machine-readable code associated with one or more products, or the cashier manually typing in a product code or other product information. In one embodiment, payment information, such as consumer account numbers, PINs, and/or other consumer and account identifiers, is entered by the consumer and/or cashier swiping a bankcard 194 through a magnetic strip reader, scanning some other machine-readable code associated with the consumer or consumer's bank account, and/or manually typing information into a keypad or touchpad. As described above, in one embodiment the prompting for, capturing of, and processing of payment data and/or product data at the POS terminal 127 is controlled by computer-executable instructions that make up the payment application 123 residing, for example, on the merchant's router/server 122 or remotely on the Internet.

As represented by block 210 in FIG. 2, in one embodiment the payment application 123 instructs the router 122 to “route” the payment transaction along a traditional electronic payment flow by, for example, routing the payment information to an acquirer 150 and/or a retail host 141. However, as also represented by block 210, the payment application 123 instructs the router 122 to route a separate information-only transaction directly to the issuing bank 170 or other entity maintaining the consumer information and promotion server 174.

More particularly, as illustrated by FIG. 2, the payment transaction, which includes all of the information necessary to debit an amount from the consumer's account with the issuing bank 170 and represents the actual electronic payment being made by the consumer 192 to the merchant 120, is sent, via a network 110, such as a telecom network or the Internet 220, to a retail host 140 (if one exists). As represented by block 225, the retail host 140 may use its own applications 141 to record information about the payment transaction and ultimately sends the payment transaction to an acquirer 150. As represented by block 230, the acquirer 150 then routes the payment transaction to the proper payment network 160, such as the VISA or MasterCard networks, which ultimately sends the payment transaction to the issuing bank 170. This flow of the payment transaction is the conventional flow of a payment transaction. Departing from convention, however, is the parallel flow, illustrated in FIG. 2, of an information-only transaction communicated directly to the issuing bank 170.

The information-only transaction includes various information about the transaction, including information about the specific products involved in the transaction. In this regard, the information-only transaction may include UPCs, SKU numbers, or other product identifiers. The information may also include information about the identity of the consumer, the merchant, the consumer account being debited or credited, the time and date of the transaction, the geographic area of the transaction, and the like. The information may include all of the information included in the payment transaction, however, in the illustrated embodiment, the information-only channel is for informational purposes only and does not represent or process the payment between the consumer and the merchant.

As represented by block 260, once the issuing bank 170 receives the information-only transaction and/or the payment transaction, the issuing bank 170 stores at least some of the data in the consumer transaction information datastore 176. When the issuing bank 170 receives the payment transaction the issuing bank 170 updates the consumer's account information datastore 172 to reflect the payment. In one embodiment, the issuing bank 170 merges the information-only transaction with the payment transaction after they both arrive from their respective channels and, as described below, in some embodiments the issuing bank 170 adjusts the payment transaction based on the information received from the information-only transaction and information in the promotion information datastore 178. As further represented by block 260, the issuing bank 170 eventually processes the payment and/or responds to merchant or other entities in the payment transaction path accordingly.

As represented by block 250, in one embodiment the payment application 123/133 instructs router 122/132 to also send the information-only transaction, or at least some product-level transaction data, to a retail host, such as a merchant's offsite retail management system 140. In this way, the system 100 can also provide the merchant 130 with records of the product information sold or returned so that the merchant 130 can manage inventory, etc. In other embodiments, however, the merchant 120 has an in-store computing device 128 and/or its own software applications 129 for recording product-level transaction information before it is sent to the payment application 123.

In another embodiment of the invention (not shown), the payment transaction itself includes product-level data, such as UPC or SKU data, and the information-only transaction may not be needed. However, such an embodiment may not be preferable since it may not be desirable from a privacy or business standpoint to provide all of the intermediate parties in the payment transaction path, such as the acquirer 150 and the payment network 160, access to a consumer's product-level data. Another issue with such an embodiment is the fact that currently many systems and parties involved in the payment transaction path are not equipped to handle additional information like UPC or SKU data. Also, in the systems described by FIGS. 1, 2, and 3, the consumer information and promotion system can be more easily modified since it involves modifying only the payment application 123/133 on each merchant's router (updates to which could be easily and automatically downloaded through the Internet) and/or one or more software applications at the issuing bank 170 or other similar entity maintaining the consumer information and promotion server 174.

Further with regard to privacy concerns, it should be noted that, in some embodiments of the invention, a consumer 192 must actively opt-into the system before his or her product-level data is recorded and/or made available to product marketers 180. In the illustrated embodiments where an issuing bank 170 maintains the consumer information and promotion server 174, a customer of the issuing bank 170 may, for example, opt-in by logging into his or her account with the issuing bank 170 over the Internet and selecting one or more levels of approval for one or more aspects of the system.

Another potential advantage of the dual channel system described in FIG. 2 stems from the fact that, in some payment transaction systems, there can be a delay before the issuing bank 170 is billed by the card association 160, payment network 160, acquirer 150, or merchant 120. However, the parallel, information-only transaction sent directly to the issuing bank 170 from the point-of-sale 127 via a high-speed network 110 such as the Internet allows for real-time transaction data to be sent to the issuing bank 170, despite the fact that there may be a delay in the payment transaction being sent along the conventional electronic payment route. In fact, in another embodiment, the information-only transaction is deliberately sent to the issuing bank 170 in advance of the payment transaction. In such an embodiment, sending the information-only transaction in advance of sending the payment transaction could allow the issuing bank 170 to verify the consumer's account balance and/or allow instant redemption of promotional offers by communicating a promotion, such as a discount, to the point-of-sale and have the payment information adjusted based on the promotion at the point-of-sale rather than at the issuing bank, as will be described in greater detail below. In other embodiments, however, the payment transaction and the information-only transaction are sent simultaneously and processed in parallel. In still other embodiments, the payment transaction is sent before the information-only transaction.

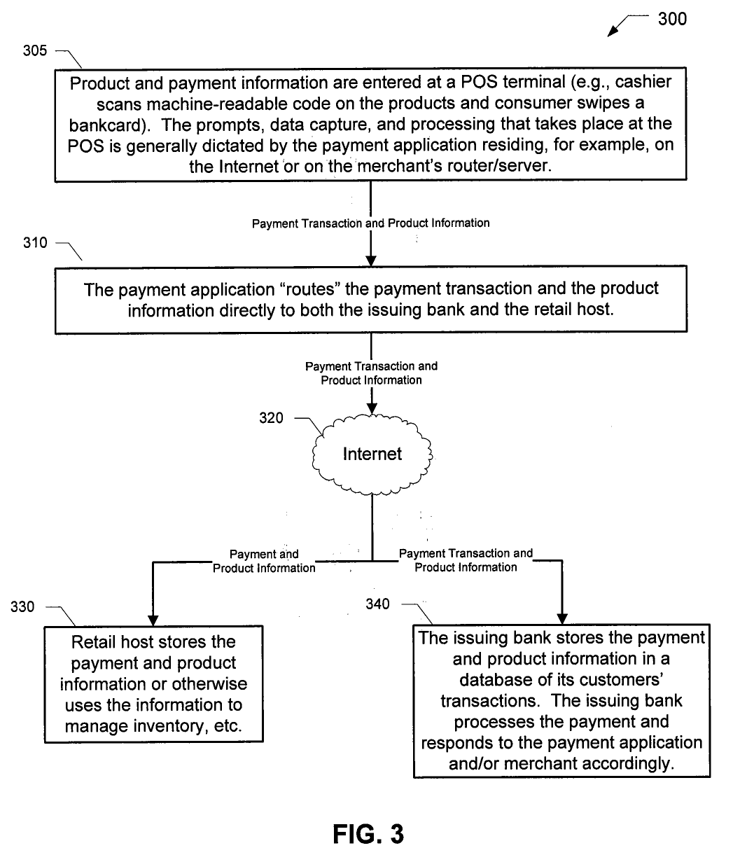

FIG. 3 is a flow diagram illustrating an electronic payment transaction process 300 in accordance with another embodiment of the present invention. As represented by block 305 and as described above with reference to FIG. 2, product and payment information are entered at a POS terminal 127. Unlike the process described above in FIG. 2, however, the process described in FIG. 3 involves the payment application 123 instructing the router 122 to route the payment transaction and the product information directly, via a network 110 such as the Internet 320, to the issuing bank 170 and, in some instances, product information directly to a retail host 141.

As represented by block 340, the issuing bank 170 stores the payment and product information in a database 176 of its customers' transactions. The issuing bank 170 also processes the payment and responds to the payment application 123 and/or merchant 120 accordingly, with, for example, a notice of payment, a notice of payment amount approval, a notice of a discount, advertisement, or other promotion, and/or the like. Similarly, a retail host 141 may store the payment and product information or otherwise use the information to manage inventory, as represented by block 330.

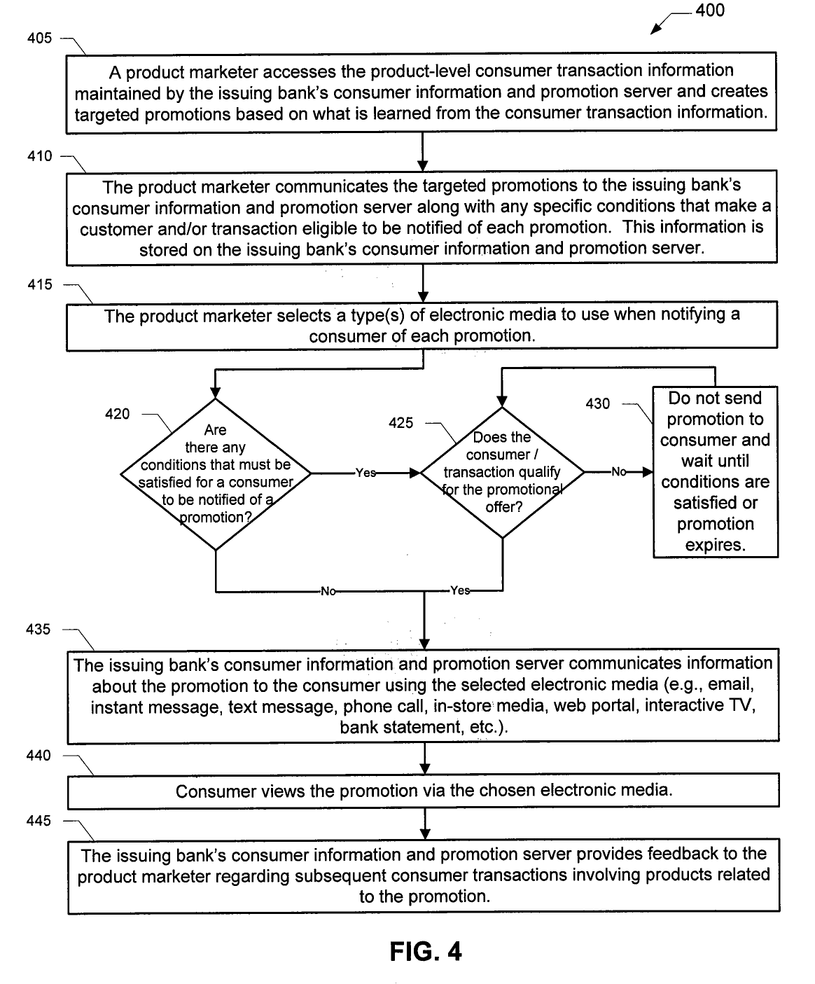

FIGS. 2 and 3 and the foregoing description disclose several process flows for delivering product-level transaction information to an issuing bank or a similar entity, where the information is then stored. Once stored, the information can be used for a number of different purposes, as described below in accordance with various embodiments of the invention. For example, FIG. 4 provides a flow diagram illustrating an advertising procedure 400 in accordance with an embodiment of the present invention.

As represented by block 405, a product marketer 180 accesses the product-level consumer transaction information datastore 176 maintained by the issuing bank's consumer information and promotion server 174 and creates targeted promotions based on what is learned from the consumer transaction information. For example, in one embodiment, a product marketer 180 pays a fee to be able to access the consumer transaction information datastore 176 via, for example, a secure connection over the Internet. The product marketer 180 can then analyze this information to determine individual consumer preferences and/or to determine categories of consumers to target with certain promotions. For example, a product marketer 180 may be able to determine which consumers are loyal to particular brands, which consumers purchase products based on sales, which consumers are willing to purchase big ticket items, which consumers go to certain types of stores, which consumers buy certain types of goods where and when, which consumers are more likely to purchase a certain good based on purchases of complimentary or competing goods, etc. With this information and some analysis of the data, a product marketer 180 can tailor promotions to one or more specific consumers. A product marketer 180 could also tailor advertisements and other promotions to be sent out to specific consumers or electronic devices based on real-time transaction information. For example, a product marketer 180 could create a promotion on the server 174 where an advertisement is sent, for example, to the display on a POS terminal or a consumer's cell phone, when a certain transaction condition is met. For example, if a consumer purchases a lawnmower at a hardware store, the promotion may be set up to recognize this and immediately send an e-mail to the consumer advertising and/or providing discounts for lawnmower attachments, grass seed, grass fertilizer, or other lawn care products. In another example, if a consumer is conducting a transaction at a store around lunch time and there is a fast food restaurant nearby to the store, the fast food restaurant may pay to create a promotion that would automatically send an advertisement for the restaurant and/or notification of discounts or specials to the consumer via, for example, the display screen of the POS terminal that the consumer is using to complete the transaction at the store.

In this regard, as represented by block 410, the product marketer 180 communicates the targeted promotions to the issuing bank's consumer information and promotion server 174 along with any specific conditions that make a customer and/or transaction eligible to be notified of each promotion. This information is stored on the issuing bank's consumer information and promotion server 174. As represented by block 415, the product marketer 180 selects one or more type(s) of media, such as electronic media, to use when notifying a consumer of each promotion. For example, the product marketer 180 might choose that the promotion be sent to the consumer via cell phone, PDA, POS terminal display, e-mail, text message, phone call, interactive TV, web page, pop-up window, and the like.

As represented by blocks 420 and 435, if the product marketer 180 does not create conditions for the promotion, the consumer information and promotion server 174 communicates, or at least initiates the communication of, the promotion to the consumers in its database, or at least the consumers that have authorized the communication of promotions. This communication is made using the one or more types of media selected by the product marketer 180.

As represented by blocks 420 and 425, if the product marketer 180 did create one or more conditions on the promotion that a consumer and/or a transaction must satisfy to be eligible to receive the promotion, then the server 174 determines whether the consumer and/or transaction satisfy these conditions. Depending on the conditions and the information in the consumer transaction information datastore 176, the server 174 could determine whether the conditions are satisfied just after the promotion is created and/or whenever information about a consumer transaction is communicated to it (e.g., when a customer 192 of the issuing bank 170 scans his or her bankcard 194). For example, if the condition on the promotion is any consumer who has purchased product “X” in the past, then the server 174 can determine the group of consumers that should receive the promotion as soon as the promotion is created. However, if the condition states that the promotion should be sent to a particular consumer or device only at the time when a consumer purchases product “Y” in the future, then the server 174 would evaluate whether this condition is satisfied each time it receives real-time information about an occurring transaction, at least until the promotion expires.

As represented by block 430, if the conditions stored in the promotion information datastore 178 are not satisfied, then the promotion is not sent to the consumer and the server 174 continues to wait until the conditions are satisfied or the promotion expires. If the conditions on the promotion are satisfied, the issuing bank's consumer information and promotion server 174 communicates information about the promotion to the consumer 192 using the selected media (e.g., e-mail, instant message, text message, phone call, in-store media, web portal, interactive TV, bank statement, etc.), as represented by block 435. As represented by block 440, the consumer then views the promotion via the chosen electronic media.

In some embodiments, the issuing bank's consumer information and promotion server 174 are further configured to use the consumer transaction information datastore 176 in conjunction with the promotion information datastore 178 to provide the product marketer 180 with feedback regarding consumer transactions involving products related to the promotion and made subsequent to the promotion being communicated to the consumer. In this way, the product marketer 180 can obtain accurate information about the success of the promotion and the return on its investment in the promotion.

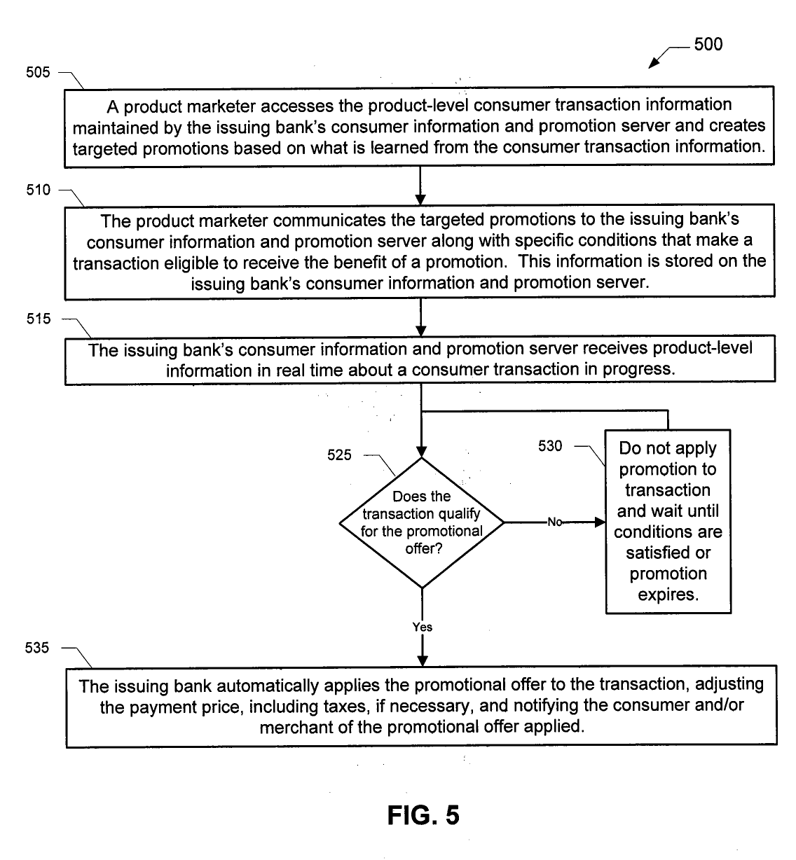

As described above, some promotions are advertisements only, but other promotions offer discounts, sales, instant rebates, rewards, buy-one-get-one-free/half-off specials, and the like. FIG. 5 is a flow diagram illustrating a procedure 500 for automatic redemption of promotional offers, in accordance with an embodiment of the present invention. As described above with regard to FIG. 4, a product marketer 180 accesses the product-level consumer transaction information 176 maintained by the issuing bank's consumer information and promotion server 174 and creates targeted promotions based on what is learned from the consumer transaction information 176. The product marketer 180 then communicates the targeted promotions to the issuing bank's consumer information and promotion server 174 along with specific conditions that make a transaction eligible to receive the benefit of a promotion. This information is stored on the issuing bank's consumer information and promotion server 174 in the promotion information datastore 178.

As illustrated by blocks 515 and 525, when the issuing bank's consumer information and promotion server 174 receives product-level information in real-time about a consumer transaction in progress, the issuing bank 170 determines whether the transaction qualifies for any promotional offers stored in the promotion information datastore 178. If the transaction does not qualify for any promotions, the server does not award or communicate any promotions and continues to wait until conditions are satisfied or promotions expire, as represented by block 530.

However, if the transaction does qualify for one or more known promotions, the issuing bank 170 automatically applies the promotional offer to the transaction. For example, in one embodiment a consumer attempts to purchase a plurality of products in a store by scanning the UPCs associated with the products and by swiping his or her bankcard. As described above, the UPC and consumer data are captured in real-time or near-real-time by the issuing bank associated with the consumer's bankcard. The consumer account number and the UPCs are then compared to promotions in the promotion information database 178 to determine whether any individual products and/or the transaction as a whole qualify for discounts or other specials. The discounts or other specials are then applied to the purchase price and the tax amount is updated if necessary.

In one embodiment, the issuing bank 170 communicates the qualifying promotional offers to the payment application 123, merchant 120, or point-of-sale 127 where the payment application 123, merchant 120, or point-of-sale 127 adjusts the purchase price accordingly and then sends the payment transaction with the revised price through the proper electronic payment path.

In another embodiment, however, where the issuing bank 170 receives both the payment transaction and the information-only transaction, then the issuing bank 170 may itself automatically adjust the payment transaction to reflect the discount or other promotional offer. For example, in one embodiment, the discount amount is calculated for each product by the issuing bank's server 174 and the transaction subtotal adjusted. Any discounts that apply to the total transaction are then also calculated by the server 174 and the total again adjusted. The server 174 may then also compute a new tax rate and apply it to the revised total. The issuing bank 170 can then process this revised lower payment amount. The revised transaction amount and individual product amounts may then be sent back to the merchant 120 via the Internet connection to the payment application 123. The payment application 123 may then be configured to use this revised data to print a new receipt and/or update the amount on the POS terminal 127 so that the consumer and/or the merchant can see that the discount was applied automatically and in real-time prior to leaving the store.

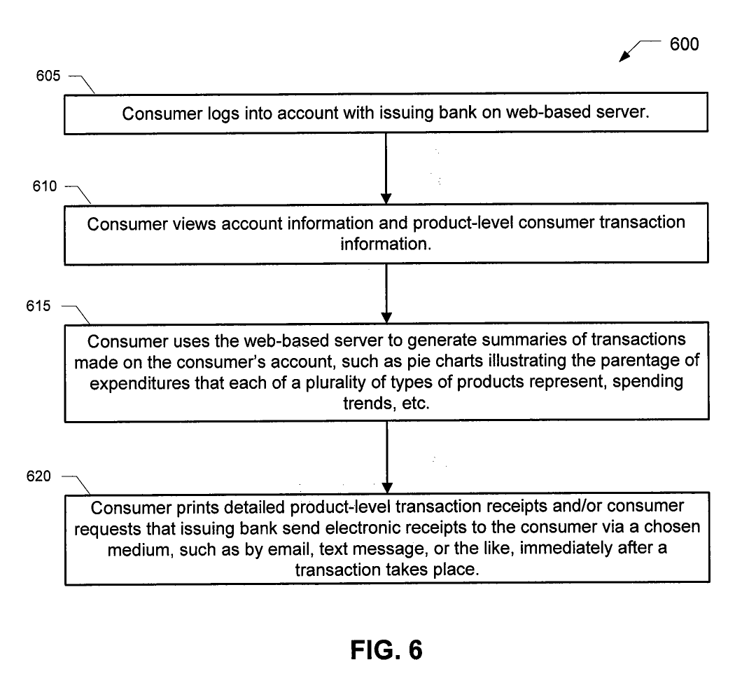

The consumer transaction information datastore 176 can also be a useful tool for customers of the issuing bank 170. For example, customers of the bank 170 that have opted into the program can use the datastore 170 to conduct analysis and prepare summaries of his or her expenditures or other transactions. FIG. 6 is a flow diagram illustrating a consumer purchase summary process 600 in accordance with an embodiment of the invention. As represented by block 605, the consumer uses a consumer terminal 190 to log into his or her account with the issuing bank 170 on a web-based server. As represented by block 610, the consumer can then not only view his or her own account information, but also view the product-level consumer transaction information associated with his or her account.

For example, as represented by block 615, in one embodiment the web-based server 174 is configured to generate summaries of transactions made on the consumer's account, such as pie charts illustrating the percentage of expenditures that each of a plurality of types of products represent or charts and graphs illustrating other spending trends by, for example, product, merchant, type of product, etc. As described above, in one embodiment this information is updated in real-time or near-real-time.

Another significant function of some embodiments of the present invention is the ability for the consumer to print receipts or duplicate receipts and/or have detailed electronic receipts automatically sent to some desired electronic device. For example, as illustrated by block 620, the consumer logged into his or her account may be able to print detailed product-level transaction receipts using the consumer transaction information datastore 176. The consumer may also be able to request that issuing bank 170 send electronic receipts to the consumer via a chosen medium, such as by email, text message, or the like, immediately after a transaction takes place. In this way, consumers and/or merchants may be able to eliminate entirely any paper receipts when the consumer uses a bankcard to pay for the transaction.

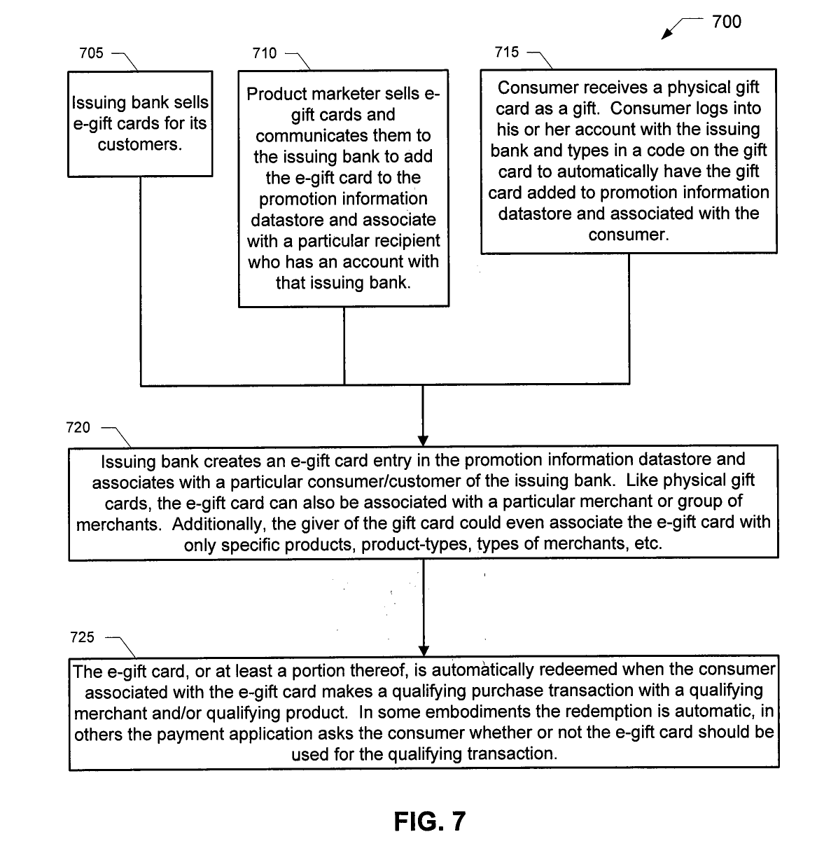

Embodiments of the present invention also allow for the creation of electronic gift cards, referred to herein as “e-gift cards.” FIG. 7 provides a flow chart illustrating a process 700 of providing for e-gift cards and the redemption thereof where a consumer uses a bankcard, in accordance with an embodiment of the invention. As represented by block 705, one way that e-gift cards can be generated is by the issuing bank 170 selling e-gift cards for its customers. As represented by block 710, another way e-gift cards can be generated is by a product marketer 180 selling e-gift cards and communicating information about them to the issuing bank 170 to add the e-gift card to the promotion information datastore 178 and associate the e-gift card with a particular recipient who has an account with that issuing bank 170. As represented by 715, yet another way e-gift cards can be generated is by a consumer receiving a physical gift card as a gift, the consumer logging into his or her account with his or her bank 170, and providing the bank 170 with a code on the gift card or other identifying information in order to have the gift card added to the promotion information datastore 178 and associated with the consumer's account with the bank 170.

Regardless of how the e-gift card is generated, the bank 170 creates an e-gift card entry in the promotion information datastore 178 and associates the e-gift card with a particular consumer/customer of the bank 170, as represented by block 720. Like physical gift cards, the e-gift card can also be associated with a particular merchant or group of merchants. Additionally, in embodiments of the present invention, the giver of the e-gift card could even associate the e-gift card with only specific products, product types, merchant types, etc. For example, a parent giving an e-gift card to a child headed off to college could specify that the e-gift card can only be used for transactions at the college bookstore and could even go further and say that the e-gift card can only be applied to the purchase of books from the college bookstore.

As represented by block 725, the e-gift card, or at least a portion thereof, is automatically redeemed when the consumer associated with the e-gift card makes a qualifying purchase transaction with a qualifying merchant and/or qualifying product. The redemption of an e-gift card generally works the same way as with the redemption of other promotions, as described above. In some embodiments the redemption of the e-gift card is automatic, however, in other embodiments the payment application 123 first asks the consumer 192 whether or not the e-gift card should be used for the qualifying transaction at this time.

Although the description provided herein generally describes embodiments of the present invention where the consumer information and promotion server 174 are maintained by an issuing bank 170 or an agent thereof, it will be appreciated by one of ordinary skill in the art in view of this disclosure that, in other embodiments of the invention, other similarly-situated institutions may maintain the server 174 or a similar server.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system comprising:
a memory device;
a communication device; and
a processing device communicably coupled to the communication device and the memory device, wherein the communication device is configured to receive product-level information and consumer-level information about a plurality of consumer transactions with a plurality of different merchants, and wherein the processing device is configured to store the product-level information and consumer-level information in the memory device.

2. The system of claim 1, wherein the product-level information and the consumer-level information are stored in the memory device such that, for each consumer of a plurality of consumers, a record is created of specific products purchased by each consumer over a period of time.

3. The system of claim 1, wherein the plurality of consumer transactions comprise consumer transactions involving a credit or debit card.

4. The system of claim 1, wherein the communication device comprises computer-readable instructions embodied in a computer-readable medium and configured to be downloaded onto a processing device held by each of the plurality of different merchants.

5. The system of claim 4, wherein the computer-readable instructions comprise instructions for routing product-level information from a point-of-sale terminal to the system's processing device.

6. The system of claim 5, wherein the computer-readable instructions comprise instructions for routing product-level information from the point-of-sale terminal to the system's processing device via the Internet.

7. The system of claim 4, wherein the computer-readable instructions comprise instructions for communicating with a plurality of point-of-sale terminals.

8. The system of claim 1, wherein the product-level information comprises one or more codes that uniquely identify one or more products involved in each consumer transaction.

9. The system of claim 1, wherein the processing device is further configured to access a data store of promotions offered by a plurality of product marketers, wherein at least some of the promotions each have one or more conditions, and wherein the processing device is configured to compare the product-level and consumer-level information with the conditions to determine whether any consumers or consumer transactions are eligible for a promotion.

10. The system of claim 9, wherein the processing device is configured to communicate a promotion to a consumer if the processor determines that the consumer or the consumer's transaction is eligible for the promotion.

11. The system of claim 9, wherein the communication device is configured to receive a payment transaction for a current consumer transaction, and wherein the processing device is configured to adjust the payment transaction based on a promotion if the processor determines that the current consumer transaction is eligible for the promotion.

12. The system of claim 9, wherein the data store of promotions is stored on the memory device.

13. The system of claim 1, wherein the system is maintained by a financial institution involved in electronic payment transactions related to the consumer transactions.

14. The system of claim 1, wherein the product-level and consumer-level information are received by the communication device in real-time or near real-time during each consumer transaction.

15. The system of claim 1, wherein the communication device is configured to allow a consumer to access the product-level information stored in the memory device associated with the consumer, and wherein the processor is configured to print itemized receipts for the consumer for each consumer transaction involving the consumer or the consumer's account.

16. The system of claim 1, wherein the communication device is configured to send the consumer itemized electronic receipts for each consumer transaction involving the consumer or the consumer's account.

17. The system of claim 16, wherein the communication device is configured to send the itemized receipts to an electronic device of the consumer's choice.

18. The system of claim 1, wherein the processing device is further configured to access a datastore of electronic gift cards having one or more conditions for use, and wherein the processing device is configured to compare the product-level information, the consumer-level information, or other transaction information with the conditions to determine if payment for a particular consumer transaction should be deducted from an electronic gift card.

19. A method comprising:
receiving electronic payment transaction information about a first product transaction involving a consumer purchasing one or more products from a first merchant;
receiving product identifying information about the identity of each of the one or more products involved in the first product transaction;
recording the product identifying information from the first product transaction;
receiving electronic payment transaction information about a second product transaction involving the consumer purchasing one or more products from a second merchant different from the first merchant;
receiving product identifying information about the identity of each of the one or more products involved in the second product transaction; and
recording the product identifying information from the second product transaction.

20. The method of claim 19, wherein receiving electronic payment transaction information comprises receiving consumer identifying information about the identity of a consumer or a consumer's financial account involved in the product transaction, and wherein the method further comprises:
recording the consumer identifying information and relating it to the recorded product identifying information.

21. The method of claim 20, further comprising:
requesting permission from a consumer to allow product marketers to access the product identifying information related to the consumer or the consumer's financial account.

22. The method of claim 20, further comprising:
accessing information about a plurality of promotions, each of said promotions having one or more conditions associated with the promotion; and
comparing the product identifying information and the consumer identifying information from the first or second product transactions to determine if the consumer or the first or second transactions qualify for a promotion.

23. The method of claim 22, further comprising:
sending the promotion to an electronic device if the consumer or the first or second transactions qualify for the promotion.

24. The method of claim 22, further comprising:
adjusting the payment transaction information for the first or second product transactions based on the promotion if the consumer or the first or second product transactions qualify for the promotion.

25. The method of claim 19, wherein the method is performed by a financial institution that maintains a consumer account involved in each of the first and second consumer transactions.

26. A method of processing a payment transaction, the method comprising:
receiving product identifying information about each of the one or more products that a consumer desires to purchase;
receiving information about the consumer's account with a financial institution; and
sending the product identifying information to the financial institution.

27. The method of claim 26, wherein the product identifying information comprises a code that uniquely identifies a product.

28. The method of claim 27, wherein the code comprises a Universal Product Code (UPC).

29. The method of claim 26, wherein sending the product identifying information to the financial institution comprises sending the product identifying information to the financial institution along with a payment transaction requesting payment from the financial institution for the one or more products.

30. The method of claim 26, further comprising:
sending a payment transaction along a first communication path, the payment transaction requesting payment from the financial institution for the one or more products; and
sending the product identifying information to the financial institution along a second communication path different from the first communication path.

31. The method of claim 30, wherein sending the payment transaction along the first communication path comprises sending the payment transaction to the financial institution indirectly through one or more other institutions, and wherein sending the product identifying information to the financial institution along a second communication path different from the first communication path comprises sending the product identifying information directly to the financial institution via the Internet.

32. The method of claim 26, wherein receiving information about the consumer's account with the financial institution comprises scanning a consumer's debit or credit card.

33. The method of claim 26 further comprising:
receiving promotion information from the financial institution in response to the product identifying information.

34. The method of claim 33 further comprising:
presenting the promotion information to the consumer.

35. The method of claim 33 further comprising:
adjusting the payment price based on the promotion information.

36. A system comprising:
a financial institution maintaining a credit or deposit account for a customer, wherein the financial institution is configured to receive product-level information about one or more products being purchased using the customer's credit or deposit account.

37. The system of claim 36, wherein the financial institution is configured to record the product-level information and associate it with the customer or the customer's credit or deposit account.

38. The system of claim 36, wherein the financial institution is configured to provide one or more product marketers access to the product-level information.

39. The system of claim 36, wherein the financial institution is configured to access information about a plurality of promotions, each promotion having one or more conditions, and
wherein the financial institution is configured to compare the product-level information to the plurality of promotions to determine if the customer purchasing the products is eligible for a promotion.

40. The system of claim 39, wherein the financial institution is configured to adjust a purchase price for one or more of the products being purchased based on one or more promotions for which the customer is eligible.

41. The system of claim 39, wherein the financial institution is configured to send information to a customer or a merchant about a promotion for which the customer is eligible.

42. The system of claim 39, wherein the financial institution is configured to maintain a datastore of the plurality of promotions, and wherein the financial institution is further configured to receive promotion information from a plurality of product marketers.

43. The system of claim 36, wherein the financial institution is configured to receive product-level information about one or more products being purchased using the customer's credit or deposit account before the purchase is completed.

44. The system of claim 36, wherein the financial institution is configured to receive payment transaction information regarding the purchase from a first communication channel and receive the product-level information from a second communication channel and merge the information from the two different communication channels.

45. A system comprising:
a point-of-sale terminal configured to receive product-level information identifying one or more products being purchased during a consumer transaction, and configured to receive account information identifying a financial account from which to receive payment for the one or more products; and
a processing device configured to send the product-level information to the financial institution that maintains the financial account.

46. The system of claim 45, wherein the processing system is configured to send the product-level information to the financial institution through a first electronic communication channel, and wherein the processing system is configured to send a request for payment for the one or more products to the financial institution through a second electronic communication channel different from the first electronic communication channel.

47. The system of claim 46, wherein the first electronic communication channel comprises the Internet.

48. The system of claim 45, wherein the point-of-sale terminal comprises a device configured to read a machine-readable code associated with the one or more products in order to receive the product-level information, and wherein the point-of-sale terminal comprises a device to read a machine-readable code associated with a consumer in order to receive the account information.

49. The system of claim 45, wherein the processing device is configured to receive communication from the financial institution regarding a promotion, wherein the processing device is configured to send the information about the promotion to the point-of-sale terminal, and wherein the point-of-sale is configured to use a user output device to present information about the promotion to a consumer.

50. The system of claim 45, wherein the processing device is configured to receive communication from the financial institution regarding a promotion before the consumer transaction is complete.

51. The system of claim 45, wherein the processing device is configured to send the product-level information to the financial institution before the consumer transaction is complete.
